(19) United States
(12) Patent Application Publication
(10) Pub. No.: US 2018/0348878 A1
(43) Pub. Date: Dec. 6, 2018

(54) Service Provider to Customer Gateway System

(71) Applicant: Ethan Koplowitz, Nashua, NH (US)

(72) Inventor: Ethan Koplowitz, Nashua, NH (US)

(21) Appl. No.: 15/614,135

(22) Filed: Jun. 5, 2017

(51) Int. Cl. G06F 3/01; G06F 17/30; G06F 3/147

(52) U.S. Cl. CPC G06F 3/017; G06F 17/3089; G06F 3/147; G06F 17/30855; G06F 17/30882

(57) ABSTRACT

A computerized system and user interface is provided that allows multiple parties to collaborate to solve environmental and energy problems in a profitable and mutually beneficial way. The system allows for economic growth through company to company collaboration, and company to customer collaboration. In particular, the system allows service providers and customers to present information in video format that also simultaneously presents hyperlinks within the video presentation. Actuation of a hyperlink can present the linked content in the same area that the video is presented in.

### BACKGROUND OF THE INVENTION

### Field of the Invention

The present invention relates generally to client to customer gateway systems. More particularly the present invention relates to a computerized online interface that allows customers, partners, and investors to view potential service providers and the products or services that they offer in the field of environmental innovation.

### Description of Related Art

The green economy is a rapidly growing and promising field. One of the more promising and exciting aspects of this green economy is the amount of enthusiasm, engagement, and solutions created by the public and small-scale innovators. However, there is a challenge of connecting these small-scale operators and enthusiasts to allow them to share ideas and information. Further, a platform to allow such users to interact, provide services and business opportunities, and learn, is greatly desirable. Especially if this interaction is done in an innovative manner.

Therefore, what is needed is a computerized platform and user interface that allows green economy (and other) enthusiasts to communicate and interact.

### SUMMARY OF THE INVENTION

The subject matter of this application may involve, in some cases, interrelated products, alternative solutions to a particular problem, and/or a plurality of different uses of a single system or article.

In one aspect, a computerized system and user interface for connecting service providers and customers for environmentally friendly development is provided. The system has a centralized computer server having a memory, the memory configured to store data relating to a plurality of service providers and a plurality of customers. Further, the memory has a user interface module. This user interface module is configured to provide a user interface to a display of a user computer that is in communication with the centralized computer server.

The user interface module operates to cause the user computer to display to present: a forum link which allows interaction of the plurality of users upon receipt of at least one gesture input from the user computer corresponding to the forum link; a customers link which provides a customer listing upon receipt of a gesture input from the user computer corresponding to the customers link; and a service provider link which provides a service provider listing upon receipt of a gesture input from the user computer corresponding to the service provider link. Further, the user interface is configured to display at least one videoette on the user interface displayed on the user computer.

The videoette, as discussed further in detail below, is configured to play a video on a videoette portion of the display of the user computer, which is a defined sup-portion of the entire area of the display of the user computer. The comprises a hyperlink area, wherein upon receipt of at least one gesture corresponding to the hyperlink area, the user interface module is configured to stop the video and to present, in the videoette portion of the display, a secondary user interface. This secondary user interface may be, for example, a web interface, from either an internal or external computer source. The user interface module allows receipt of the at least one gesture over the videoette portion of the display to interact with the second user interface and it can be browsed within the videoette area as if it were a stand alone web (or other) interface. As such, the videoette configuration provides a unique solution to the problem of providing video-based information, and as a user seeks further information, presents this further information within the existing system user interface in a contained manner without leaving the user interface. While discussed in detail being used as part of a system to allow collaboration for the advancement of green energy technologies, it should be understood that this videoette aspect of the invention may be applied to any other sort of web interface or computerized system without straying from the scope of this invention.

### BRIEF DESCRIPTION OF THE DRAWINGS

FIG. 1 provides a view of an embodiment of an implementation of the present inventive system.

FIG. 2 provides a view of another embodiment of an implementation of the present inventive system.

FIG. 3 provides a partial view of an embodiment of an implementation of the present inventive system.

FIG. 4 provides a view of still another embodiment of the present inventive system in use.

FIG. 5 provides a view of another embodiment of the present inventive system in use.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

Some embodiments of the present invention may be practiced on a computer system that includes, in general, one or a plurality of processors for processing information and instructions, RAM, for storing information and instructions, ROM, for storing static information and instructions, a data storage unit such as a magnetic or optical disk and disk drive for storing information and instructions, modules as software units executing on a processor, an optional user output device such as a display screen device (e.g., a monitor) for display screening information to the computer user, and an optional user input device.

As will be appreciated by those skilled in the art, the present examples may be embodied, at least in part, a computer program product embodied in any tangible medium of expression having computer-usable program code stored therein. For example, some embodiments described below with reference to flowchart illustrations and/or block diagrams of methods, apparatus (systems) and computer program products can be implemented by computer program instructions. The computer program instructions may be stored in computer-readable media that can direct a computer or other programmable data processing apparatus to function in a particular manner, such that the instructions stored in the computer-readable media constitute an article of manufacture including instructions and processes which implement the function/act/step specified in the flowchart and/or block diagram. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In the following description, reference is made to the accompanying drawings which are illustrations of embodiments in which the disclosed invention may be practiced. It is to be understood, however, that those skilled in the art may develop other structural and functional modifications without departing from the novelty and scope of the instant disclosure.

Generally, the present invention provides a system and computerized user interface for putting service providers and producers in touch with customers and potential customers. The system brings parties together to solve environmental and energy problems. The system may operate to facilitate communications and presentations between individuals, company to company, company/individual to investor, company/individual to consumer, and the like. Further generally, the system includes a computerized server which generates a user interface accessible by a user's host computer. The user interface allows users to view forums, advertisements, and other details, as well as viewing “videoettes” which are herein used to describe videos that provide hyper linked data which may be presented in the user interface, and optionally in the video display region, upon receiving an input corresponding to the hyper link in the video display region. Videoettes will be described in more detail, below. In combination, the present invention provides a new and unique system to allow collaboration for the advancement of green energy technologies.

The system of the present invention may be accessible through a web browser interface. In such an interface, a number of services may be provided. For example, an interactive web forum may allow users to communicate. Further, a mall interface may allow users to purchase, trade, and auction items or services in the green technology fields. In some embodiments, a company and non-profit section may be provided as a separate page or section of the interface to allow users to search and research the different organizations engaged in the inventive system. In still further embodiments, a live chat or live video forum may allow users to interact in real time with other system users of the user interface. In another embodiment a world leaders and intellectual leaders may provide information and strategies in a separate page or section of the interface. In still another embodiment, a field operations section or page may allow users, through the user interface, to see photographs, pre-recorded and live videos of current projects. This section may include a question and answer series where users may ask questions and receive answers, in real time or with a delay regarding the projects and their progress. Throughout the user interface of the present invention, videoettes may be distributed throughout the interfaces and in a separate page or section to allow users to be maximally exposed to the videoettes.

In one embodiment, the computerized system may include a forum interface. The forum interface may be accessible via the web interface and may allow uses to ask questions and get answers regarding environmental topics. Further, the forum may allow users to share stories, learn through others, including through games and videos. In some embodiments, a videoette creation module (discussed below) may allow forum users to create videos with interactive elements. The forum interface may be integrated into the system's web interface, and accessible by, for example, received gestures and/or inputs by a computer accessing the present inventive system.

In another embodiment, the computerized system may include a mall interface. The mall interface allows users to purchase, trade, and/or auction items related to environmental products. The mall interface may be integrated into the system's web interface, and accessible by, for example, received gestures and/or inputs by a computer accessing the present inventive system. In a particular embodiment, the mall interface may include a live video interface allowing two or more users to interact by videoconference. The video interface may include a live video conference with a sales expert, seller, forum, and the like. In other embodiments, pre-recorded videos may be implemented and embedded in the user interface. Further, the mall interface may include a calendar interface to schedule discussion and presentations via a video chat interface. This calendar may be used in other aspects such as seeking investors and the like, and is not necessarily limited to the mall interface.

In certain embodiments of the mall interface, the computerized system may be configured to provide a consistent user interface within the system interface. This allows vendors from external websites to include their listings on the user interface of the present invention without leaving the user interface for the external website. In operation, the system may access and consolidate identified information on an external website, and may then automatically generate a listing within the mall interface corresponding to this item.

In yet another embodiment, the computerized system may include a live chat or live video forum may allow users to interact in real time with other system users of the user interface

In yet another embodiment, the computerized system may include a field operations section or page may allow users, through the user interface, to see photographs, pre-recorded and live videos of current projects.

The term videoette, as used throughout this disclosure refers to a combination of interface and video display of the present invention that is a unique and specialized interface that combine viewing of interactive videos and also web browsing or other information presentation within the web-embedded video screen area. For example, a videoette may begin as a video (either automatically played, or played by a user gesture/input activation). The video includes at least one link presented within the video play area. The link may be positioned over the playing video, may be a specific area of the video, and/or may be a particular target in the video (such as a particular moving character). When the user interface receives an input corresponding to the link, the video may be either minimized or stopped, and in the same area in which the video is viewed, a web interface may be presented corresponding to this link. The web interface may be internal on the present system's web interface, or may be an entirely separate external web interface, such as that of an external web site.

Generally, the videoettes contemplated herein may be short videos or advertisements that include a hyperlink to allow viewer to instantly be connected with a second web interface. The second web interface may, for example, contain important additional information about the company/product/service, an external or internal web site, online store, communication gateway, live chat interface, and the like to which the video relate. An important optional feature of the videoettes is that the links present the related information within the existing web interface video area. This prevents a user from leaving the interface of the present system. Further, by containing the videoette-related content to within the video viewing area, the present invention user interface retains its look and feel and allows seamless and continuous browsing. In one embodiment, a videoette initially starts as embedded video and then upon activation of the hyperlink, the content from the linked website is embedded automatically in the same interface as the videoette. Videoettes may include links over the top of the video, or a single link anywhere on the video.

The videoette-related content in the second web interface is not limited to an external website. Videoette-related content may also include, but is not limited to further live or prerecorded presentations, audio presentations such as podcasts, file downloads, and the like.

The videoettes may be embedded in the user interfaces of the present invention in various fashions. For example, in one embodiment, the videoettes may be embedded in portions of the user interface in the periphery of the content area, such as on a top, bottom, or side. In another embodiment, the videoette may be highlighted at a center of a viewing area of the user interface. Further, the videoettes may be positioned adjacent to traditional advertisements, and/or may include a pre-playing advertisement before the videoette. Further still, the videoette itself may be an advertisement. However, the may also may pop out in certain embodiments into a full screen or partial screen view. Further, videoettes may be accessible directly by hyperlink, allowing sharing of them via correspondence, social media, email, and the like. In one embodiment, a single videoette may play. In another embodiment, a plurality of videoettes may be played in series. Further still, using the calendar noted above, scheduled videoettes may be played at scheduled times, allowing live viewing by multiple users at the same time. Videoettes may be assigned a particular identifier such as a number or code, allowing users to save and re-access them on demand.

In a particular embodiment, the present invention may include, as part of the user interface, a module to allow creation of a videoette based on an existing video. The module may allow a user to select a portion of the video to make the hyper link, or a plurality of portions for a plurality of hyperlinks. A user may then input the desired web address for the hyperlink. The system may then automatically edit the video to create linkable areas, and to configure the linkable areas to be displayed in the same video area as the video is played in. The videoette module may be separate from, or integrated into the web interface of the system. For example, a stand alone machine or stand alone computerized module may allow creation of videoettes, which then may be uploaded to or accessible by the system's user interface. In a separate machine embodiment, a videoette maker may go out into a remote area to create the videoette, and then may send the created videoette via a data connection back to the system. In a particular embodiment, a drag and drop interface may allow users to input a video into the videoette module, and drag to select a link area, and drag to identify the hyperlinks by dragging the text of a link to an identified area. When editing in the videoette module, links and other features may be activated or deactivated as selected.

In a particular area of the user interface, a listing of companies that are engaged or associated with the environmental and energy problems sought to be solved through the present inventive system. Similarly, a non-profit section may identify non-profit organizations that do the same. Further, a section having field operations demonstrating what is being done on various green solutions may be presented in a particular section. These may include photographs, live or prerecorded videos, and/or a question and answer listing.

In operation the system may be operated in a number of different manners. For example, a traditional computerized user interface may be used to access the various user interface aspects by mouse/trackpad clicking or actuation. Further, a touch screen interface may be utilized that records touch inputs and/or gestures. Further still, the user interface may be optimized for verbal command user interface, allowing a user to navigate the web interface, including navigating videoettes via voice activated hyperlinks.

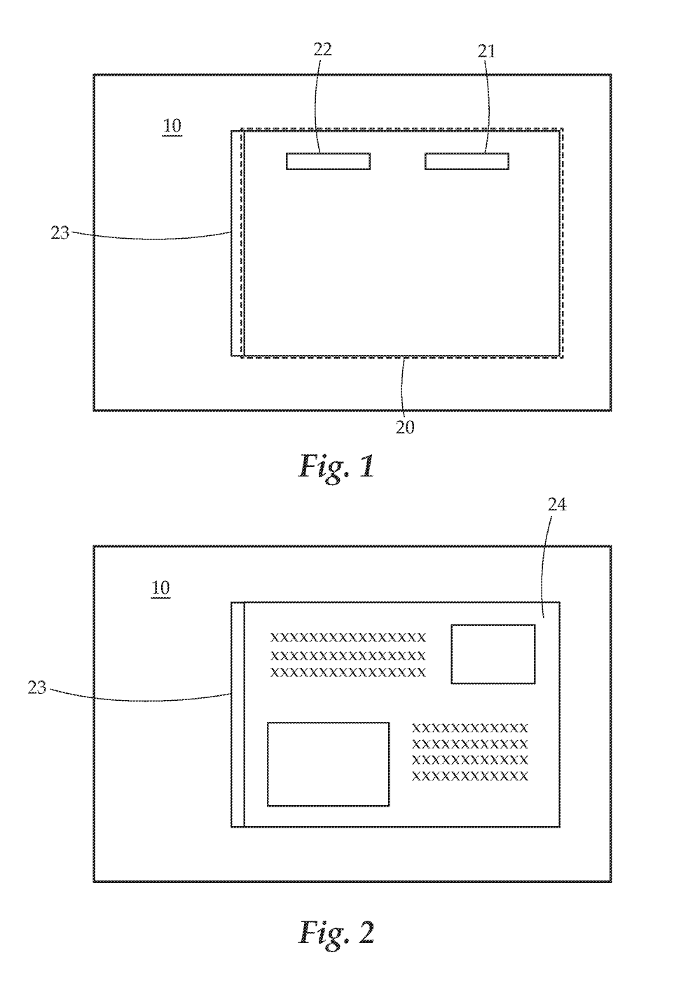

Turning now to FIG. 1, an embodiment of a user interface of the present invention is provided showing the operation of a videoette. In this view, videoette 20 is displayed on a portion of a display screen. As discussed, the videoette 20 may play a video. Two portions of this video comprise hyperlink areas which direct the computer to display the hyperlink sources. These hyperlink areas shown in this embedment as link 1 21, and link 2 22. Before, during, and after playing of the video, these link areas on the display screen are capable of receiving an input, such as a gesture input can be identified and received by the system of the present invention. Upon receipt of the gesture, the system's user interface presents the linked within the predefined videoette area of the display, shown in this view as area 23. This allows the videoette area 23 to display a second web interface within the first web interface 10 of the system.

The result of receiving a gesture corresponding to a hyperlink can be seen in FIG. 2. In this view, the first web interface 10 includes the videoette area 23, but instead of the video, a user has gestured on a hyperlink area 21, 22, which has directed the videoette viewing area 23 to display content of the second web interface 24, which is now embedded within the web interface 10's videoette area 23.

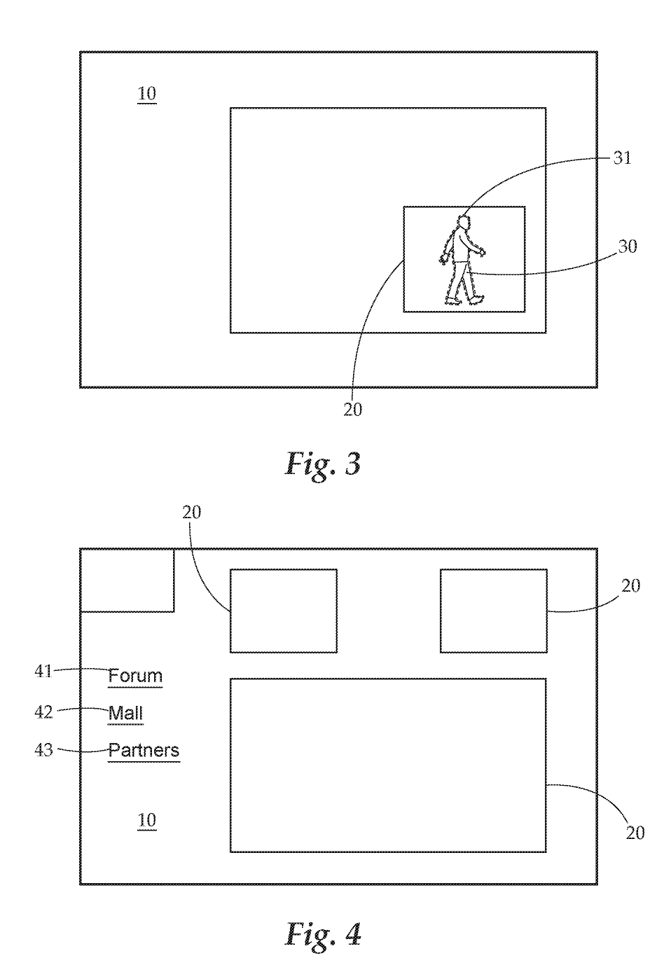

FIG. 3 shows another embodiment of the present invention wherein the hyperlink area is movable as the video plays, corresponding to a particular video element. In the example shown, the videoette 20 is positioned in a portion of the system's web interface 10. The hyperlinked area of this embodiment corresponds to a video object 30 and an area around this object 31. In this view, the video object 30 is a person moving through the video. Upon receipt of a gesture, as discussed above with respect to FIGS. 1 and 2, the user interface may cause the second web interface to be displayed within the videoette area.

FIG. 4 provides a view of another embodiment of the display of the user interface, which is a web interface, of the present inventive system. In this view, a plurality of videoettes 20 are displayed in certain areas of the user interface display. These may begin playing upon a gesture by a user via a system input, or automatically. Also displayed on the left column of the display is a forum link 41, a mall link 42, and a partners link 43. These may take the user to portal as discussed above.

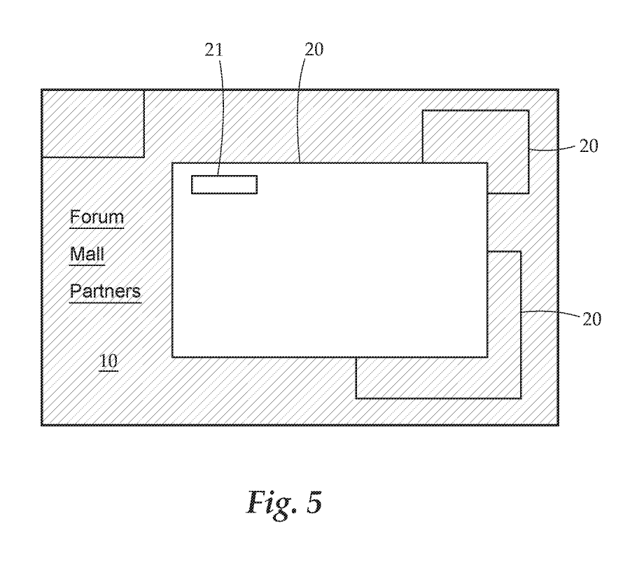

FIG. 5 provides a view of an embodiment of the user interface of the present invention which presents a selected videoette in a pop out view such that all other portions of the user interface are dimmed. In this view, a small videoette may be selected, which will be expanded to cover or overlap some of the user interfaces other elements. The videoette 20 is then more prominently displayed in the user interface. As with other videoettes, a hyperlink area 21 allows users to access a second user interface, through the videoette 20. In this embodiment, the second user interface may be viewed while the remainder of the user interface is dimmed.

The computerized graphical user interface may be in communication with one or more computing devices in networked communication with each other. The computer or computers of the computerized user interface contemplated herein may comprise a memory, processor, and input/output system. In some embodiments, the computer may further comprise a networked connection and/or a display screen. These computerized elements may work together within a network to provide functionality to the computerized user interface. The computerized user interface may be any computerized interfaces capable of allowing a user to input data and receive a feedback. The computerized user interface may further provide outputs executed by the system contemplated herein.

The gestures discussed herein may be any input received by a user interface of a computer. Examples of gesutres may include, but are not limited to: keystrokes, mouse or similar clicks, touch screen inputs such as tap, swipe, pinch, etc., audio inputs such as voice commands, and mobile computer motions such as tilting, shaking, and the like.

As noted the videoette operation in the present system provides a unique solution to the problem of presenting further information within the existing system user interface in a contained manner (in a previously defined video area) without leaving the user interface.

The present invention utilizes a computerized system to solve a number of technical problems that are significantly more than generic computer functions. For example, the system solves the computer-based problem of keeping a system user viewing an existing web page but also displaying external or different web content. In the prior art, a user would be taken to an external website. However, in the present invention, the system automatically populates content in a videoette viewing area, which is the same area which was previously playing a video until a gesture is received from a user. Further, the system utilizes graphical user interface(s) to allow users and customers to operate the systems in unique, new, and non-obvious ways.

This invention performs a number of operations that could not be performed by a human using mental steps or pen and paper. For example, a non-computerized system could not receive a gesture input from a user in a videoette link area, and based on this gesture input, stop the video and in the place of the video (in the same defined area) display a different content, such as a web content, additional video, and the like. This user interface presentation operation is a computer-specific problem and could not be performed using mental steps or without the computerized system.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

What is claimed is:

1. A computerized system and user interface for connecting service providers and customers for environmentally friendly development comprising:
a centralized computer server having a memory, the memory storing data relating to a plurality of service providers and a plurality of customers, the memory further comprising a user interface module;
wherein the user interface module is configured to provide a user interface to a display of a user computer in communication with the centralized computer server, the user interface module causing the user computer display to present:
a forum link, allowing interaction of the plurality of users upon receipt of at least one gesture input from the user computer corresponding to the forum link;
a customers link providing a customer listing upon receipt of the at least one gesture input from the user computer corresponding to the customers link;
a service provider link providing a service provider listing upon receipt of the at least one gesture input from the user computer corresponding to the service provider link; and
at least one videoette, the videoette configured to play a video on a videoette portion of the display of the user computer, the videoette further comprising a hyperlink area, wherein upon receipt of the at least one gesture corresponding to the hyperlink area, the user interface module is configured to stop the video and to present, in the videoette portion of the display, a secondary user interface, and wherein the user interface module allows receipt of the at least one gesture over the videoette portion of the display to interact with the second user interface.

2. The computerized system and user interface of claim 1 wherein the secondary user interface comprises a web interface comprising data from a source not stored on the centralized computer server.

3. The computerized system and user interface of claim 1 wherein the secondary user interface comprises web interface comprising data from a source stored on the centralized computer server.

4. The computerized system and user interface of claim 1 wherein the secondary user interface comprises a live video presentation.

5. The computerized system and user interface of claim 1 wherein the secondary user interface comprises a prerecorded video presentation.

6. The computerized system and user interface of claim 1 further comprising a project status link, allowing display of at least one projects relating to one of the plurality of service providers and plurality of users upon receipt of at least one gesture input from the user computer corresponding to the project status link.

7. The computerized system and user interface of claim 1 further comprising a live video chat link, allowing at least two of the plurality of customers to correspond using direct video communication upon receipt of at least one gesture input from the user computer corresponding to the live video chat link.

8. The computerized system and user interface of claim 1 wherein the hyperlink area of the videoette is in a fixed position.

9. The computerized system and user interface of claim 1 wherein the hyperlink area of the videoette moves through a playing of the video.

10. The computerized system and user interface of claim 1 wherein the at least one gesture is a voice input recorded through a microphone of the user computer.

11. The computerized system and user interface of claim 1 wherein the at least one gesture is a touch input recorded by a touch screen of the user computer.

12. The computerized system and user interface of claim 1 wherein the at least one gesture is a mouse click input recorded by a mouse of the user computer.

13. The computerized system and user interface of claim 1 further comprising a plurality of videoettes, a first videoette displayed on the videoette display area, and a second videoette displayed on a second videoette display area that is separate from the videoette display area.

14. The computerized system and user interface of claim 1 wherein the videoette comprises a first video having a first hyperlink area, and a second video configured to be played after the first video if the first hyperlink area has not been gestured on by the user, the second video comprising a second hyperlink area.

15. The computerized system and user interface of claim 1 wherein the videoette comprises a plurality of hyperlink areas, wherein upon receipt of the at least one gesture corresponding to a first of the plurality of hyperlink areas the user interface module is configured to stop the video and to present, in the videoette portion of the display, the secondary user interface, and wherein upon receipt of the at least one gesture corresponding to a second of the plurality of hyperlink areas, the user interface module is configured to stop the video and to present, in the videoette portion of the display, a tertiary user interface.
